(19) United States
(12) Patent Application Publication
(10) Pub. No.: US 2007/0220785 A1
(43) Pub. Date: Sep. 27, 2007

(54) Tickets

(76) Inventors: Frank Forgione, West Melbourne (AU); Russell Shewan, West Melbourne (AU)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/572,426

(22) PCT Filed: Jul. 21, 2005
(86) PCT No.: PCT/AU05/01069

§ 371 Date: Jan. 22, 2007

(30) Foreign Application Priority Data
Jul. 21, 2004 (AU) 2004904031

(51) Int. Cl. G09F 3/02

(52) U.S. Cl. 40/27

(57) ABSTRACT

The present invention relates to tickets for events, and in particular to a method for fulfilling a ticket order from a customer and to an integrated ticket and ticket-carrier. The method for fulfilling a ticket order includes the steps of receiving ticket data from or relating to a customer and electronically providing the ticket data to a ticket service provider to produce a ticket in accordance with the ticket data and introduce the ticket into a postal or similar delivery system for delivery to the customer. Such a method has the result of separating the ticket production and distribution functions from the ticket originating function. The integrated ticket and ticket carrier includes a foldable sheet having an arrangement of perforations or other frangible elements defining at least one ticket area that is readily removable from the sheet. This avoids the need for a separate ticket wallet, and allows minimal stock types to be used to provide unlimited quantities and varieties of tickets.

### FIELD OF THE INVENTION

The present invention relates to tickets for events and the like. In particular the present invention relates to a method for fulfilling a ticket order from a customer and to an integrated ticket and ticket carrier.

### BACKGROUND OF THE INVENTION

In this specification, where a document, act or item of knowledge is referred to or discussed, this reference or discussion is not an admission that the document, act or item of knowledge or any combination thereof was at the priority date part of common general knowledge, or known to be relevant to an attempt to solve any problem with which this specification is concerned.

Although there has been an undoubted move towards replacing paper tickets with various forms of electronic ticketing, paper tickets are still commonly issued for many events. Paper tickets have a number of advantages over electronic tickets, including improved security features and the ability for a customer to retain a ticket as a souvenir of the event.

Printing and delivering tickets for large events, such as the sporting tournaments, and the Commonwealth or Olympic Games, is a massive undertaking, which event organisers often contract out to third party ticket agencies. Ticket agencies are significant commercial undertakings in their own right, with large investments in ticket allocation software and ticket production hardware.

Ticket agencies provide a ‘front end’ to customers, through which tickets for specified events are purchased. Tickets are often ordered through call centres, where operators take customer orders over the telephone and arrange payment for the tickets, usually by credit card. The operator then enters the details of the customer's order into a database and the tickets are printed.

The most labour-intensive steps of the process take place after the tickets are printed, when the tickets are manually inserted into a wallet, (often along with relevant advertising material), the wallet placed into an envelope, address labels printed and affixed to the envelope, and the envelope franked and then delivered to the postal service for delivery to the customer. Many ticket agencies employ dedicated staff to carry out these steps.

Ticket agencies may sell thousands of tickets to different events on a daily basis, and delays of 4 or 5 days between ordering tickets over the telephone and arrival of the tickets in the post are common. It would therefore be advantageous to develop a method for fulfilling ticket orders that lessens this delay and simplifies or streamlines the order fulfilment process flow.

Closed-face envelopes are currently used to send tickets through the post, as there is a risk with window-faced envelopes that the tickets may be viewed through the window and possibly stolen from the envelope. However, use of closed-faced envelopes adds to the number of process steps of the ticket order fulfilment process (and therefore the cost), by necessitating the printing of labels, each of which must be manually or mechanically affixed to the envelope. It would also be advantageous to be able to use window-faced envelopes to send tickets though the post, in a way that substantially reduces or minimises any associated security risk.

### SUMMARY OF THE INVENTION

According to a first aspect of the present invention, there is provided a method for fulfilling a ticket order, the method including the steps of:
receiving ticket data from a customer; and
electronically providing the ticket data to a ticket service provider to produce a ticket in accordance with the ticket data and introduce the ticket into a postal delivery system for delivery to the customer.

The present invention overcomes the disadvantage of the prior art by separating the ticket production and distribution functions from the ticket originating function. The step of receiving ticket data from a customer is typically carried out by a ticket agency and may be implemented through any known communication channel, such as over the telephone, via email or through a web site. However, in contrast to the prior art, the ticket agency which receives the order from the customer (who may be an individual or an organisation) is not responsible for physically producing the ticket and mailing it to the customer.

The method can be used by any ticket agency and can be fully customised, including providing that the ticket carries or is associated with the agency's identity.

Preferably, the ticket service provider is substantially controlled by the owner or operator of the postal delivery system. For example, the ticket service provider may be a part of the national postal authority, or may be a division of a national courier delivery organisation.

The method includes the further step of electronically forwarding advertising material to the ticket service provider for incorporation into or association with the ticket, the advertising material being selected in accordance with stored information related to the customer. This form of the invention allows cross marketing, such as cross marketing between the different entities involved in the process.

In a preferred form, the ticket data includes customer data, and the advertising material is selected in accordance with said ticket data, preferably in accordance with the customer data.

The advertising material may be generated by any convenient means known to those skilled in the art. The advertising material may be selected in accordance with the ticket data from the present or previous ticket purchase transactions by the customer. The advertising material may be generated by analysing the ticket data relating to the customer, stored in a database during previous ticket purchases, the analysis used to select the advertising material from a number of predefined possibilities.

Preferably, the ticket produced by the ticket service provider is integrally formed with a ticket carrier, the integrated ticket and ticket carrier being inserted into a window-faced envelope by the ticket service provider and forwarded to the customer. In this way, customer delivery information may be provided on the ticket carrier and printed as part of the ticket production process.

Collectors' tickets may be printed on the fly or as special runs.

Optionally, the ticket carrier includes a personalised salutation addressed to the customer, the salutation being generated from the ticket data.

According to a second aspect of the present invention, there is provided an integrated ticket and ticket carrier, including a foldable sheet having an arrangement of perforations or other frangible elements defining at least one ticket area that is readily removable from the sheet.

In a preferred form, the integrated ticket and ticket carrier is for use with a window-faced envelope, the sheet having customer delivery information printed thereon, the at least one ticket area being positioned on the sheet such that when the sheet is folded for placement in a window-faced envelope, the customer address but not the at least one ticket area may be viewed through the envelope window. The sheet may also carry additional ‘non-secure’ information, such as return address information, which is preferably positioned to be viewable through an additional envelope window.

In contrast with the prior art, this aspect of the invention avoids the need for a separate ticket wallet, and allows minimal stock types to be used to provide unlimited quantities and varieties of tickets. The stock sheets can be numbered or otherwise individually or uniquely identified, in order to provide complete reconciliation, including integrity between a first ticket carrier and any subsequent ticket carriers in the same order. In addition to numbering, appropriate identification formats may include barcodes, optical recognition marks, glyphs, etc.

Preferably, the sheet is divided along its length into a first end section, a middle section and a second end section, the customer address located in the first end section and a ticket area located in the middle section. This embodiment allows the sheet (such as a standard A4-size sheet) to be ‘concertina folded’ (for insertion into a standard B4-sized window-faced envelope) so that said first end section is superimposed over and obscures said middle section and said second end section. The folded sheet may thus be inserted into a window-faced envelope, with the customer address, but not the ticket area being viewable through the window.

Importantly, in accordance with this aspect of the invention, the integrated ticket and ticket carrier, carrying the associated customer delivery information, may be printed on a single sheet, and possibly in a single printing step, thus considerably simplifying the production process and substantially increasing the speed and reducing the cost of ticket order fulfilment.

Several integrated ticket and ticket carriers in accordance with the invention may be folded in a similar manner to a conventional letter and placed in a single window-faced envelope. A second ticket area may also be located in the second end section, allowing two separate tickets to be provided on a single sheet. One of the ticket areas may be a blank ticket, so that any number of tickets can readily be produced using common stock.

Preferably, the arrangement of perforations includes a line of perforations running along a boundary of the middle section and either of the first and section end sections, such that the sheet may be folded along at least one of the said boundaries without folding along the ticket areas.

The arrangement of perforations or other frangible elements may define ticket areas of uniform or varying size. Embodiments of the invention in which the ticket areas differ in size allow, for example, two tickets—which may be for two different events taking place at different venues, each involving their own unique ticket acceptance machinery—to be provided on a single sheet and forwarded to the customer as part of a single ticket order.

Portions of the sheet not used as ticket areas may be provided with advertising material or other indicia, such as public transport vouchers. The ticket carrier may also be provided with invoicing information, enabling it to be retained after the tickets have been removed from the sheet, so as to serve as a tax invoice for the ticket purchase if required.

In this specification and claims, it will be appreciated that the term “ticket” embraces similar or analogous articles such as vouchers, coupons, credits, etc.

### BRIEF DESCRIPTION OF THE DRAWINGS

A brief description of an embodiment of the present invention will now be described by reference to the accompanying drawings in which:

FIG. 1 is a schematic view illustrating the method of the present invention and the various parties involved;

FIGS. 2A and 2B show the front and rear face of an example of an integrated ticket and ticket carrier in accordance with the present invention;

FIGS. 3A and 3B show the front and rear faces of an example of an integrated ticket and ticket carrier in accordance with the present invention, provided as a follower sheet to the sheet illustrated in FIGS. 2A and 2B;

FIG. 4 illustrates the folding process and the use of the integrated ticket and ticket carrier with a window-faced envelope;

FIGS. 5A and 5B show the front and rear faces of a further example of an integrated ticket and ticket carrier in accordance with the present invention; and

FIGS. 6A and 6B show the front and rear faces of yet a further example of an integrated ticket and ticket carrier in accordance with the present invention.

### DETAILED DESCRIPTION OF THE DRAWINGS

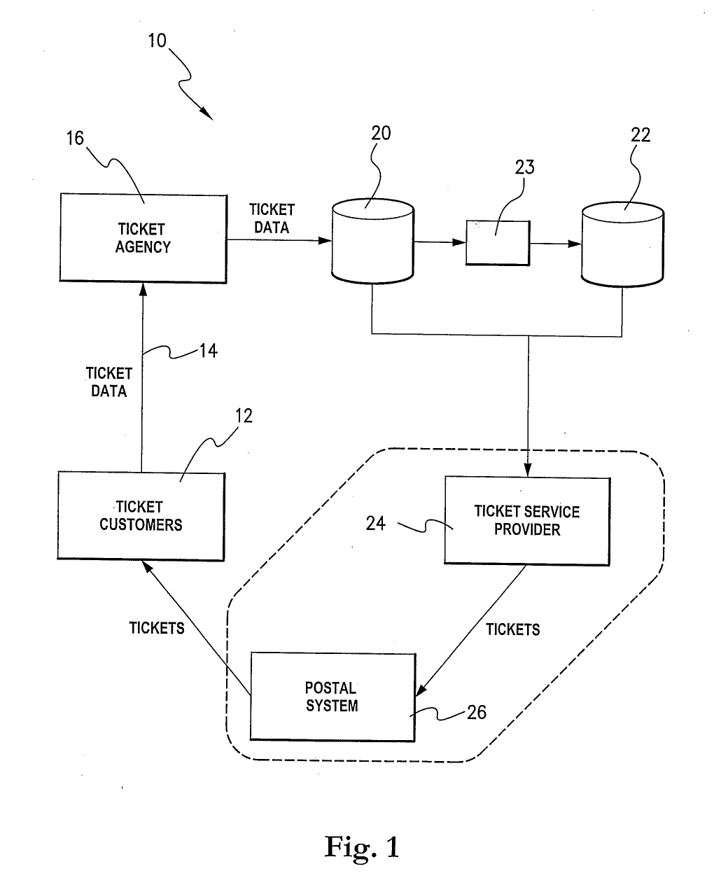

Turning to FIG. 1, a system 10 for fulfilling ticket orders in accordance with the invention is illustrated. Customers 12 contact a ticket agency 16 to purchase tickets for a specific event. Customers 12 communicate with the ticket agency 16 directly or indirectly (e.g. though ticket agency outlets) through a channel 14 which can be by telephone, email or Internet connection, or by any other suitable communication means. Upon receipt of the order at the ticket agency 16, the relevant details of the customer such as name, address and payment mode, and of the ticket or tickets ordered (the particular event, the ticket quantity, etc) are entered into a ticket database 20. The ticket agency may utilise a card payment gateway (not shown) to process orders where the payment mode is by debit or credit card.

The ticket data passed to database 20 includes the information required to order a ticket for a specific event, pay for the ticket and have the ticket delivered via the appropriate delivery channel, and thus includes customer data such as name and delivery details. Where communication with ticket agency 16 is over the telephone, ticket data obtained from the customer is entered manually into ticket database 20 by a call centre operator. Where customers 12 purchase tickets through email or via a web site, the ticket data can be automatically extracted and entered into ticket database 20.

Ticket database 20 is accessible to a ticket service provider 24, being a business entity separate from the ticket agency and responsible for the physical production and forwarding of tickets to the customer 14. Ticket service provider 24, periodically and/or when required, accesses or receives the ticket data from ticket database 20 and prints tickets in accordance with the ticket data. The preferred format of tickets is described in further detail below. Ticket service provider 24 is also responsible for consolidating, sorting, and bar-coding the tickets and for lodging the tickets into the postal system 26, for delivery to the customer 12. Preferably, the ‘next day delivery’ service of the postal system is utilised to deliver the tickets to the customer 12.

To fully leverage the economies of scale provided by the method of the present invention, the ticket service provider is owned or controlled by the operator of postal system 26, such as the owner, as schematically illustrated in FIG. 1. The postal system may be a national postal authority or may be a private courier system, such as ‘FedEx’ or DHL. Separating ticket agency functions from ticket production functions, whilst combing ticket production functions with ticket delivery functions, allows for a significantly more efficient use of existing infrastructure, that in the prior art has either been duplicated amongst, or not fully utilised by, the separate entities involved in the process flow.

Ticket service provider 24 is further configured to access or received advertising material from an advertising database 22, for inclusion with or on the customer's tickets. Alternatively, the advertising material may be delivered to the ticket service provider in some other suitable manner, such as hard copy. The advertising material is selected or generated by a data mining engine 23 that operates on ‘raw’ ticket data stored in the ticket database. A customer's own ticket data from the current or previous ticket purchases is a rich source of relevant information, from which advertising material that is specifically targeted to a particular customer's interests or ticket purchase activity can be generated, using data mining techniques already known in the art and not described in further detail herein.

In addition to traditional purchases initiated by the customer (referred to as ‘pull’ purchases) ticket provision may be by way of unsolicited marketing (referred to as ‘push’ sales). Push sales enable inactive tickets for an event to be mailed or otherwise provided to selected customers (such as customers who are identified as having purchased tickets to similar previous events), providing them with an invitation to optionally ‘activate the ticket’. Activation is then achieved by the customer paying for the tickets in any prescribed manner, such as by telephone, over the counter, via SMS, online etc. At or via the point of payment, the ticket reference number is activated by the event organiser or ticketing agency. The push sales process can provide a powerful direct marketing tool to the events industry.

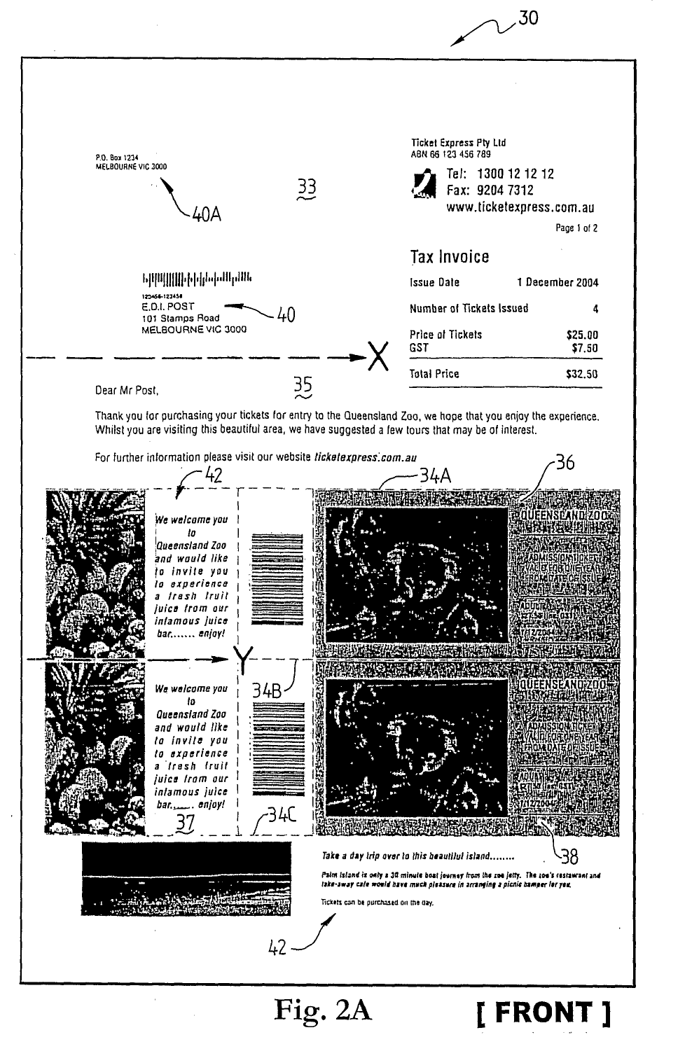

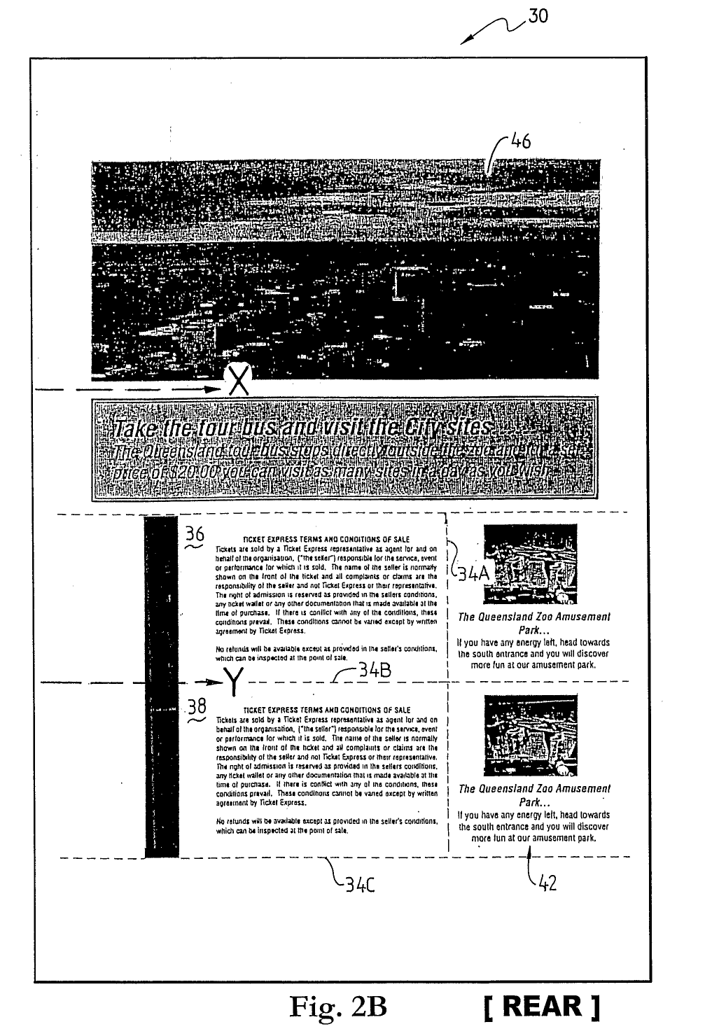

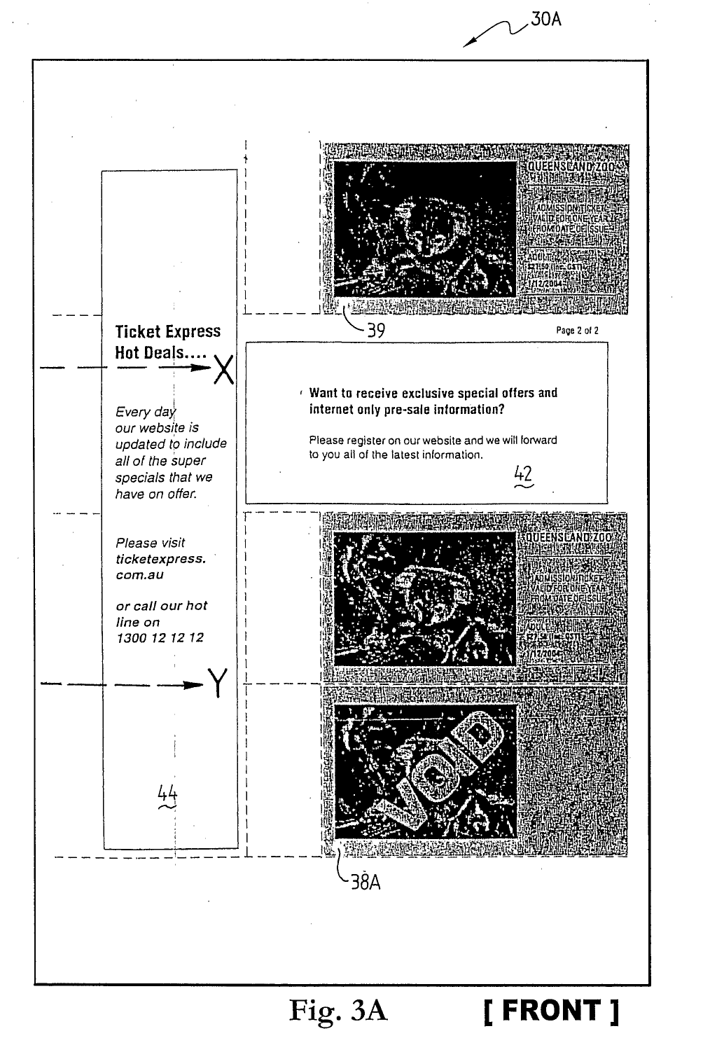

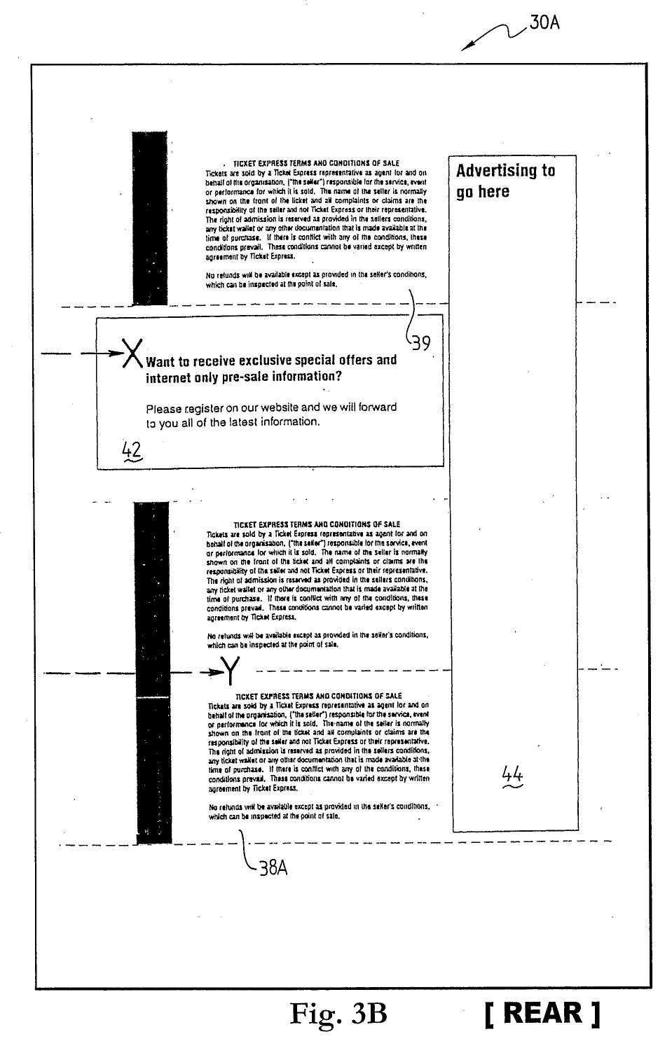

An example of a form of ticket produced by the ticket service provider in accordance with the invention is illustrated in FIGS. 2A and 2B. Further examples are illustrated in FIGS. 3A,3B; 5A,5B; and 6A;6B.

The ticket takes the form of an integrated ticket and ticket carrier 30 formed from a single sheet of material, preferably of a heavier stock than standard copy print paper. In a preferred embodiment, A4 cut sheet stock is used, but the invention can by carried out using any appropriate size of weight of sheet stock, including continuous feed paper stock, card, plastic, or other printer-friendly material.

An arrangement of perforations, comprising transversely extending perforation lines 34A, 34B and 34C and longitudinally extending perforation line 35, define first ticket area 36 and second ticket area 38 on the sheet (further perforations may also be provided within the ticket areas themselves, e.g. if required for use at the event venue). Ticket areas 36, 38 are printed with all required the ticket data (including magnetic stripes, barcodes, holograms, UV-readable data, thermochromic indicia, microtext, iPaper, coin-rub ink, integrated semiconductor device, and/or other security information required) to form tickets that may be easily removed from the ticket carrier 30 by simply tearing along the lines of perforation. The ticket carrier portion may then be discarded, or retained for taxation or records purposes if tax invoice details are also printed on the ticket-carrier.

On the rear sides (see FIG. 2B), ticket areas 36 and 38 may be printed with terms and conditions relevant for entry to the event, and these can be fixed (standard) terms, or variable in accordance with the event. This latter option enables common ticket stock to be used for different event types, or in the event of changes in terms and conditions over time.

Additionally, variable images may be printed onto the ticket areas or carrier portions, in accordance with advertising criteria or other nominated variables. For example, commemorative stock can be produced bearing limited edition photographs or background imagery for premium seating.

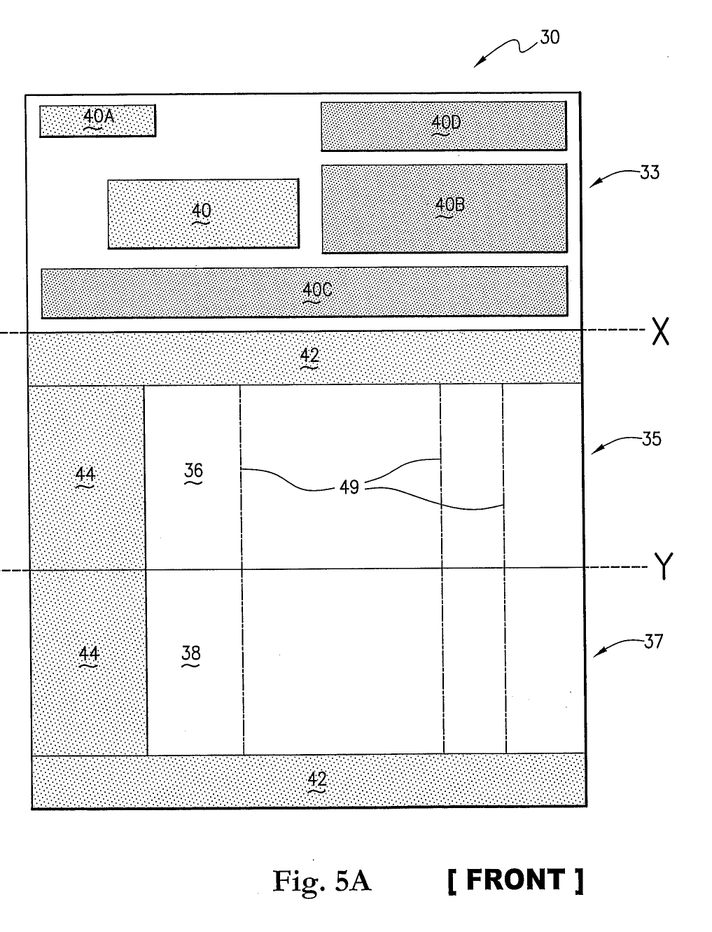

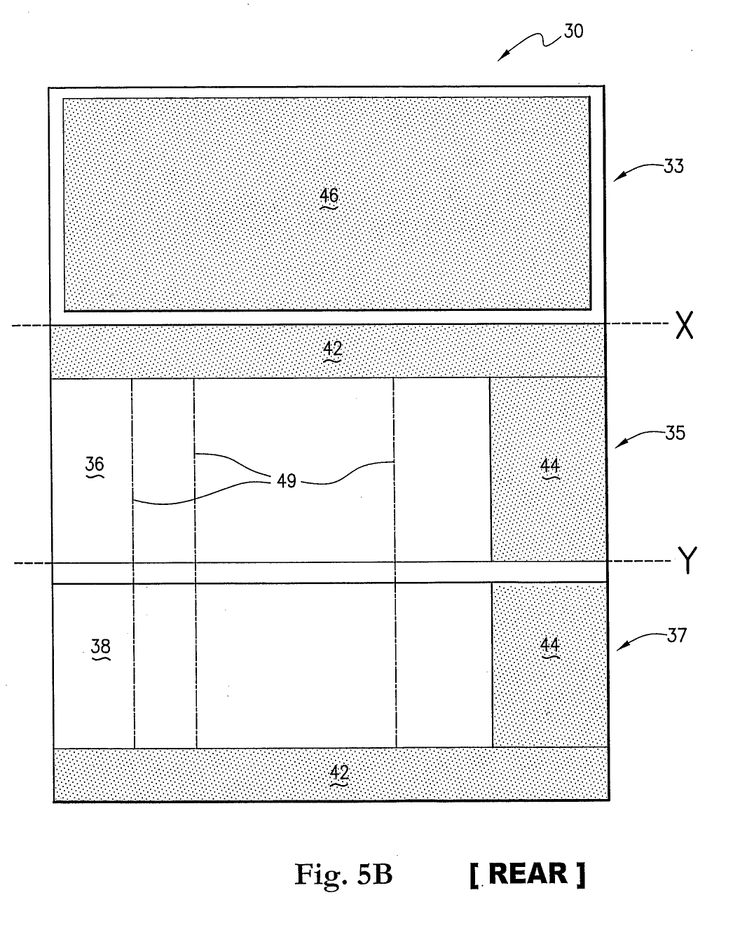

As discussed above, advertising material, including customised (targeted) advertising material, may be printed onto the integrated ticket and ticket carrier. By way of further example, FIGS. 5A and 5B depict a similar example to that of FIGS. 2A;2B and 3A;3B, but show an alternative arrangement of advertising and other printing areas. The targeted advertising material referred to above is printed directly onto the ticket-carrier in areas 42, 44 and 46. The advertising material 42 may take any appropriate form, such as advertising for other related ticketed events, for products or services otherwise related to the particular event (e.g. for suitable public transport services to the event), or product or services otherwise selected to be of interest to the particular customer. Advertising for public transport services, or even the incorporation of a public transport ticket or voucher into the ticket carrier, can be targeted towards particular customers who are likely to use such services, with such preferences being assessed through the data mining techniques referred to above. Selected areas—such as areas 44 in FIGS. 5A;5B and 6A;6B—may be provided as removable coupons or vouchers with peripheral perforations. Other areas, such as area 46 in the figures, may provide additional information for customers, such as directions to or maps of venues, parking information, etc. Personalised information in the advertising or information areas may be driven by the information in database 23. The tickets themselves may be provided with advertising and voucher areas and/or appropriate perforations 49 for ready removal of such portions.

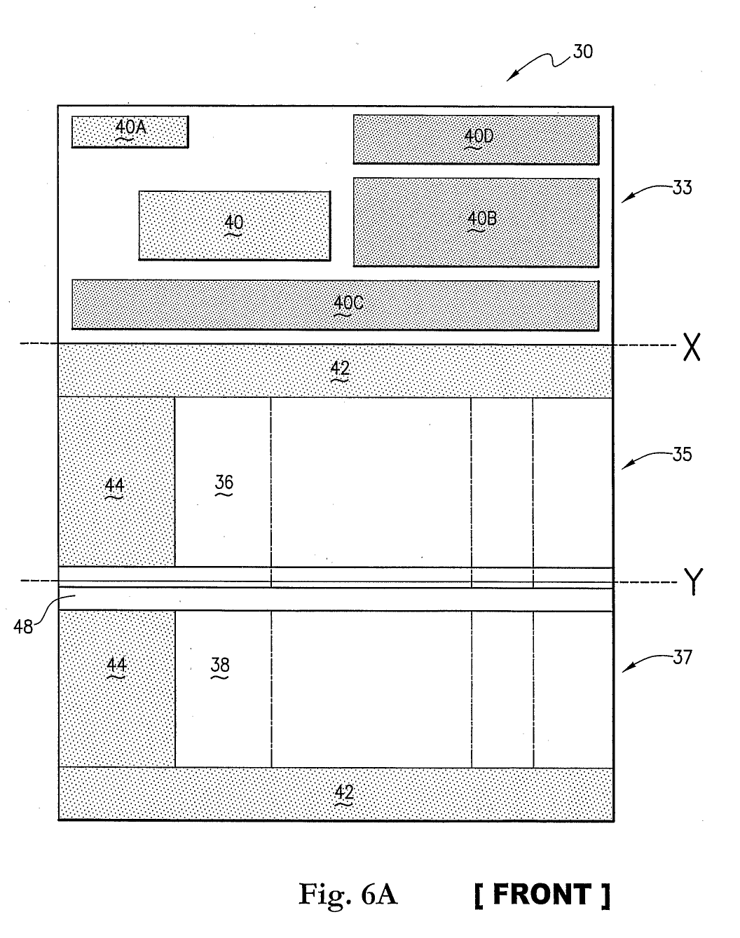

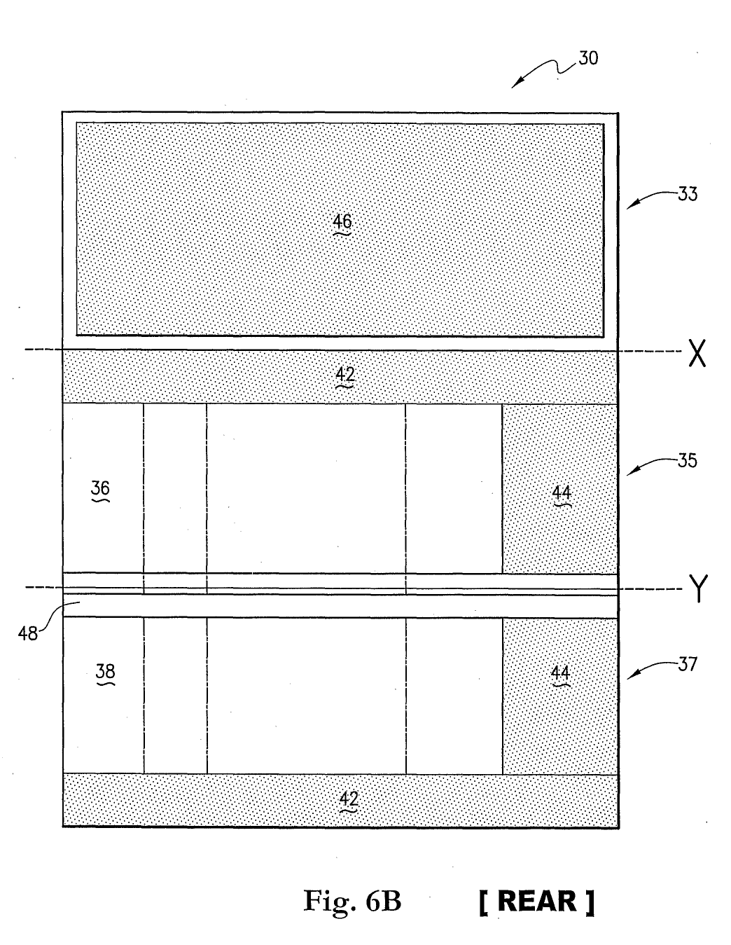

The ticket-carrier may also include an indication that the tickets have been paid for by credit or debit card, this information also being extracted from ticket data provided by the customer 12 and accessible to ticket service provider 24 through ticket database 20, in order to provide a credit/debit card receipt and/or tax invoice (see area 40B in FIGS. 5A and 6A).

The ticket areas 36 and 38 are shown with uniform size. However, this is not essential and ticket areas of differing sizes and formats may readily be incorporated, to allow tickets for events at different venues, each having differing ticket-validating machinery, to be included in a single sheet 30.

Turning once more to FIG. 2A, sheet 30 is divided along its length into three sections 33, 35 and 37 of roughly the same size, these sections separated by imaginary lines (corresponding to intended fold lines) X and Y. Ticket areas 36 and 38 are only provided in middle and lower sections 35, 37 of the ticket carrier 30, with a transversely extending line of perforations 34B extending along the boundary Y between the middle 35 and lower section 37. Customer delivery information 40, which includes a customer address and corresponding encoded bar code data as shown, generated from the ticket data referred to above, is printed in a conventional location on the upper section 33 of sheet 30.

As illustrated in the example of FIGS. 5A and 6A, further printed areas may be provided in upper section 33, including reply paid address area 40A, tax invoice area 40B, customised greeting message area 40C, and ticket agency or other corporate logo/details area 40D. Tax invoice area 40B can be separable from the ticket carrier by way of peripheral perforation lines.

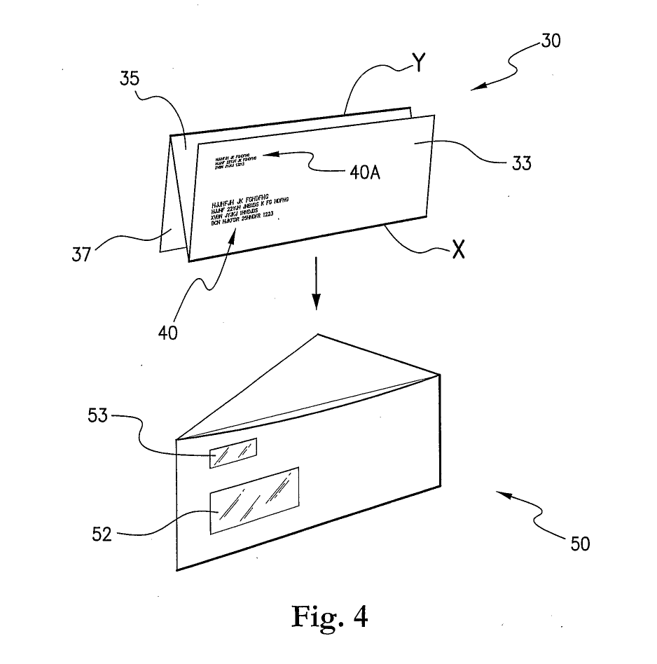

This configuration on integrated ticket and ticket carrier 30 of ticket areas 36, 38 and delivery information 40 allows the sheet to be concertina folded along the section boundaries X and Y in a conventional manner, in just the same way as a standard letter. Once folded, upper section 33 overlays and obscures middle and lower sections 35 and 37 so that the folded sheet can be inserted into a window-faced envelope 41 and only the delivery information 40 can be viewed through the envelope window 43 (see FIG. 4). This is an important feature with respect to security considerations, as ticket areas 36 and 38 (as well as other confidential information) cannot be viewed through the window, and to an outsider the mail item appears to be nothing more than a conventional letter. As discussed above, the ability to use a window-faced envelope results in reduced costs and increased efficiency in fulfilling ticket orders, as the need to individually print labels or individual envelopes for each ticket dispatch is eliminated. An additional, smaller window 43 in envelope 41 may be provided, in order to allow a return address (preferably a Post Reply Box) 40A to be viewed without the need to open the envelope. If the ticket service provider is a postal authority, undelivered returns can thus be readily reconciled as part of the overall business process.

Locating the perforated line 34B along the boundary Y between the sheet middle and end sections 35 and 37 also allows the ticket carrier 30 to be folded without folding and damaging either of the tickets.

Optionally, both fold lines X and Y may feature lines of perforations, which provide accurate and crisp lines for folding the ticket carrier, reducing the risks of unwanted folds inadvertently occurring on a sheet and allowing ready folding of sheets both manually and by machine.

FIGS. 3A and 3B show a further integrated ticket and ticket carrier provided as a follower sheet 30A, for placing and mailing in a window-faced envelope along with sheet 30. As shown, sheet 30A is not required to include ticket delivery information, and instead a third ticket area 39 is provided in sheet 30A, within the boundaries of upper sheet section 33, such that folding along fold line X does not fold the ticket provided in area 39. Using a single front sheet 30 and multiple follower sheets 30A, any number of tickets can therefore be provided in a single mailout. In this example, the customer has ordered a total of 4 tickets, provided on a single mailout comprising sheets 30 and 30A. Only two different paper stock types are required, regardless of the number of tickets comprised in the order, and in this example the lower ticket area 38A on sheet 30A is left blank and void.

The printing of sheet 30/30A may take place in a multi-pass process, whereby the tickets are printed by one process step (incorporating the required security features, for example a high resolution full colour print step), and the ticket-carrier information is printed in one or more separate process steps (such as a B&W print step, which provides personalisation such as targeted advertising and vouchers, customer name and address details, seating location, further ticket details, etc). The printing of the sheets may In a fully integrated process, sheet 30/30A may be printed on both sides with both ticket and carrier information in a single machine in a single process step. Further, the stock used may be pre-perforated, or the perforating may be carried out as an inline part of the printing process. The one-pass process minimises stock requirements and reduces ticket production time.

As FIGS. 6A and 6B illustrate, an additional feature of the integrated ticket and ticket carrier, tolerance bands or ‘fold bands’ 48 can be incorporated into the front and back of the sheets. These are appropriately positioned spaces provided between the tickets to allow for the tolerances of folding and inserting machinery, and to allow for variations in the fold positions as the number of ticket followers increases. Optionally, a perforation may run through the centre line of the tolerance band to facilitate ready hand folding as required.

The above-described method for fulfilling ticketing orders includes delivery to the customer by way of the postal system, courier service or other fulfilment process. However, integrated ticket and ticket carriers produced in accordance with the present invention may alternatively be printed and provided to customers in an ‘over-the-counter’ process. In accordance with such a process, the printing can be decentralised and take place at a point of sale ticket outlet. This enables local printing of tickets at ticket sales facilities, removing the need for ticket data to be forwarded to a central location for printing, folding, inserting and delivery.

Modifications and improvements to the invention will be readily apparent to those skilled in the art. Such modifications and improvements are intended to be within the scope of this invention.

1. A method of fulfilling a ticket order which includes multiple tickets for a plurality of different events, comprising the steps of:
receiving electronic ticket order data including ticket information and customer delivery information;
providing a supply of foldable sheets having an arrangement of perforations or other frangible elements defining multiple prescribed ticket areas readily removable from the sheet;
printing ticket information onto at least one of the prescribed ticket area of a first sheet, and printing customer information and/or other information in the remaining area of said first sheet;
if and as required by said ticket order, printing information onto at least one of the prescribed ticket areas of one or more further sheets, and printing customer information and/or other information in the remaining area of said one or more further sheets; and
providing the resulting printed integrated ticket carrier sheets of sheets to the customer.

2. The method of claim 1, wherein said supply of foldable sheets comprises pre-cut sheet stock of two different types, a first sheet stock type used to provide said first sheet of the order, and a second sheet stock type used to provide said further sheet or sheets.

3. The method of claim 1, wherein customer delivery information is printed on said remaining area of said first sheet.

4. The method of claim 3, wherein other information such as advertising material is printed on said remaining area of said one or more further sheets.

5. The methods of claim 1 including the step of, if a sheet is printed with ticket information and one or more ticket areas on that sheet are not required for said ticket order, printing voiding indicia in those areas.

6. The method of claim 1 carried out by a ticket service provider responsible for the distribution of the resulting printed integrated ticket and ticket carrier sheet or sheets to the customer.

7. A method for fulfilling a ticket order, the method including the steps of receiving ticket data from or relating to a customer and electronically providing the ticket data to a ticket service provider to provider to produce a ticket in accordance with the ticket data and introduce the ticket into a postal or similar delivery system for delivery to the customer, said ticket service provider being responsible for the distribution of the resulting printed ticket to the customer.

8. The method of claim 7, wherein the step of receiving ticket data from a customer is carried out by a ticket agency, and the ticket data is provided to the ticket service provided together with ticket agency identity information, for incorporation into or for association with the ticket.

9. The method of claim 7, including the step of electronically forwarding advertising material to the ticket service provider for incorporation into or for association with the ticket, the advertising material being selected in accordance with information related to the customer.

10. The method of claim 9, wherein the ticket data includes customer data, and the advertising material is further selected in accordance with said customer data.

11. The method of claim 9, wherein the advertising material is selected in accordance with the ticket data from the present or previous ticket purchase transactions by the customer.

12. The method of claim 11, wherein the advertising material is generated by analysing the ticket data relating to the customer stored in a database during previous ticket purchases, the analysis used to select the advertising material from a number of predefined possibilities.

13. The method of claim 7, wherein the ticket is a provisional ticket produced in accordance with data relating to a customer and deliver to the customer for optional activation, the method including the step of receiving validation from the customer and amending the ticket data to record the ticket as an activated ticket.

14. The method of claim 7, wherein the ticket produced by the service provider is integrally formed with a ticket carrier, the integrated ticket and ticket carrier insertable into a window-faced enveloped by the ticket service provider to be provided or forward to the customer.

15. An integrated ticket and ticket carrier suitable for used in fulfilling a ticket order which includes multiple tickets for a plurality of different ticketed events, the integrated tickets and ticket carrier comprising a foldable sheet having an arrangement of perforations or other frangible elements defining multiple prescribed ticket areas readily removable from the sheet, the prescribed ticket areas printed with ticket information or left blank/voided as required to fulfil said ticket order.

16. The integrated ticket and ticket carrier of claim 15, wherein the foldable sheet comprises pre-cut sheet stock.

17. The integrated ticket and ticket carrier of claim 15, for use with a window-faced envelope, the sheet having customer delivery information printed thereon, the at least one ticket area being positioned on the sheet such that when the sheet is folded for placement in a window-faced envelope, the customer delivery information but not the at least one ticket area may be viewed through the envelope window.

18. The integrated ticket and ticket carrier of claim 15, wherein the sheet carries additional information, such as return address information, positioned to be viewable through an additional envelope window.

19. The integrated ticket and ticket carrier of claim 15, including an individual sheet identifier.

20. The integrated ticket and ticket carrier of claim 15, wherein the sheet is divided along its length into a first end section, a middle section and a second end section, the customer address located in the first end section and a ticket area located in the middle section and/or the second end section.

21. The integrated ticket and ticket carrier of claim 20, wherein the arrangement of perforations or other frangible elements includes a line of perforations running along a boundary of the middle section and either of the first and section end sections, such that the sheet may be folded along at least one of the said boundaries without folding along a ticket area.

22. The integrated ticket and ticket carrier of claim 20, wherein the sheet areas adjacent one or more of the boundaries between the middle section and the first and section end sections are not printed, to provide tolerance bands for folding of the sheet.

23. The integrated ticket and ticket carrier of claim 15, printed in a single printing step to provide both ticket information and customer delivery information.

24. The integrated ticket and ticket carrier of claim 15, wherein said multiple prescribed ticket areas are of differing sizes.

25. The integrated ticket and ticket carrier of claim 15, wherein portions of the sheet not used as ticket areas are provided with advertising material or other indicia, such as coupons or vouchers.

26. The integrated ticket and ticket carrier of claim 15, wherein portions of the sheet not used as ticket areas are provided with invoicing information.

27. A printed ticket product including a plurality of integrated ticket and ticket carrier each comprising a foldable sheet in accordance with claim 15, one said sheet being a header sheet having customer delivery information printed thereon, and the other said sheet or sheets being follower sheet(s) providing the number of tickets requiring to fulfil said ticket order.
